(19) United States
(12) Patent Application Publication
(10) Pub. No.: US 2003/0167190 A1
(43) Pub. Date: Sep. 4, 2003

(54) System and method for preventing fraud and mistake in the issuance, filling and payment of medical prescriptions

(76) Inventors: Barbara A. Rincavage, Brodheadsville, PA (US); Cynthia E. Rincavage, Breinigsville, PA (US)

Correspondence Address: Eric A. LaMork, P.O. Box 434, Yardley, PA, 19067-8434, US

(21) Appl. No.: 10/086,253

(22) Filed: Mar. 1, 2002

(51) Int. Cl. G06F 17/60

(52) U.S. Cl. 705/3; 340/573.1

(57) ABSTRACT

A system and method for tracking the proper execution of a medical prescription from the time it is prescribed by a physician to the time it is filled by a pharmacist, signed for, paid for and received by the recipient in the pharmacy. The system includes a database. Unfilled prescriptions are entered into the database by authorized physicians. When the patient goes to a pharmacist or another medical service provider to fill the prescription, the medical service provider accesses the database to retrieve the details of the prescription. The exact details of how the prescription is filled is entered into the database. The details of how the prescription is filled is automatically compared to the original prescription. If there is any discrepancy between the original prescription and how the prescription is filled, a warning is generated.

### BACKGROUND OF THE INVENTION

1. Field of the Invention

The present invention relates to systems and methods that enable physicians and pharmacists to electronically intercommunicate. More particularly, the present invention relates to such systems and methods that enable physicians to electronically transmit prescriptions to pharmacists and other medical service providers, in a manner that prevents mistake, abuse and insurance fraud.

2. Prior Art Statement

Traditionally, when a patient visits a doctor and is prescribed either a medication or a medical serve, that patient leaves the doctor's office with a written prescription. If the prescription is for a medication, the patient takes the prescription to a pharmacist who fills the prescription. If the prescription is for a medical service, the patient takes the prescription to the medical service provider.

If the patient does not have insurance, the patient directly pays the pharmacist or the medical service provider. However, if the patient has insurance, the patient pays a predetermined co-payment amount, if any, and the pharmacist or medical service provider seeks the remaining amount from the patient's insurance company.

In the traditional mode of operation described, there are many opportunities for mistakes and fraud to occur. Since prescriptions are typically hand written by physicians, a pharmacist may make a mistake in the medication, dosage or amount stated in the prescription. Such mistakes can have adverse health consequences on the patient. Alternatively, dishonest people may fake prescriptions or alter prescriptions to serve their own purposes.

In the prior art, there are many systems designed to prevent a pharmacist from misreading a prescription or enabling a patient to alter a prescription. Such systems typically use a database that is accessed by both physicians and pharmacists. The physician inputs a prescription into the database and the pharmacist reads the prescription from the database. In this manner, there are no concerns about penmanship and a patient does not have the opportunity to falsify a prescription. Such prior art prescription compliance systems are exemplified by U.S. Pat. No. 6,067,524 to Byerly, entitled Method And System For Automatically Generating Advisory Information For Pharmacy Patients Along With Normally Transmitted Data; and U.S. Pat. No. 5,883,370 to Walker, entitled Automated Method For Filling Drug Prescriptions.

Unfortunately, it is not always dishonest patients that attempt prescription fraud. Fraud is also rampant among dishonest pharmacists and medical service providers who attempt to illegally obtain money from either the patient or the patient's insurance company. Dishonest pharmacists have been known to fill prescriptions with generic drugs and charge insurance plans the price of name brand drugs. A subtler scam is that some dishonest pharmacists only partially fill prescriptions saying that they do not have enough medication on hand to fill the whole prescription. The patient is then required to visit the pharmacist more than once, thus paying multiple insurance co-payments for a single prescription. The pharmacist may also charge more per pill for a smaller number of pills, since a volume discount would not apply. Cases also exist where pharmacists steal certain drugs and alter hand written prescriptions to compensate for the theft.

Prior art systems that transmit information between a doctor and a pharmacist do help reduce pharmacy mistakes and reduce patient fraud. However, such systems have no mechanism for preventing fraud committed by a pharmacy or other medical services provider. A need therefore exists for a system and method that better tracks a prescription. This need is met by the present invention system and method, as described and claimed below.

### SUMMARY OF THE INVENTION

The present invention is a system and method for tracking the proper execution of a medical prescription from the time it is prescribed by a physician to the time it is filled by a pharmacist, signed for, paid for and received by a recipient in the pharmacy. The system includes a database. Unfilled prescriptions are entered into the database by authorized physicians. A paper prescription is also given to a patient for the prescription. When the patient goes to a pharmacist or another medical service provider to fill the prescription, the medical service provider accesses the database to retrieve the details of the prescription. In this manner the written prescription is not relied upon and the possibility of prescription tampering by the patient is eliminated. Once the prescription is accessed by the medical service provider, the prescription is filled. The exact details of how the prescription is filled are entered into the database. The details of how the prescription is filled are automatically compared to the original prescription. If there is any discrepancy between the original prescription and how the prescription is filled, a warning is generated. The warning is sent to either the prescribing physician and/or the insurance company of the patient. In this manner, mistakes and/or fraud on the part of the pharmacist can be greatly reduced.

If a patient dies or still has a renewable prescription, the death of the patient is added to the database. Similarly, if a prescription is lost or stolen, this information can be reported to the patient's physician and entered into the database. At the time the prescription is renewed, the database is checked. If the patient is listed as deceased, or if the prescription is listed as lost or stolen, the renewal rights to the prescription and/or the rights to have a new prescription filled are cancelled. This prevents prescriptions from being renewed by unauthorized people.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic of the overall system in accordance with the present invention;

FIG. 2 is a schematic of the registration process used by the present invention system;

FIG. 3 is a block diagram logic flow illustrating some method steps used by physicians while utilizing the present invention system; and

FIG. 4 is a block diagram logic flow illustrating some method steps used by medical service providers while utilizing the present invention system.

### DETAILED DESCRIPTION OF THE INVENTION

Although the present invention system and method can be used to regulate and verify the fulfillment of any type of a doctor's prescription, such as a prescription to get an X-ray or to obtain medical equipment, the system and method are especially useful in regulating and verifying prescriptions for pharmaceuticals. As such, by way of example, the present invention system and method will be described in an application where it is used to obtain a pharmaceutical prescription from a pharmacy, in order to present the best mode contemplated for the invention.

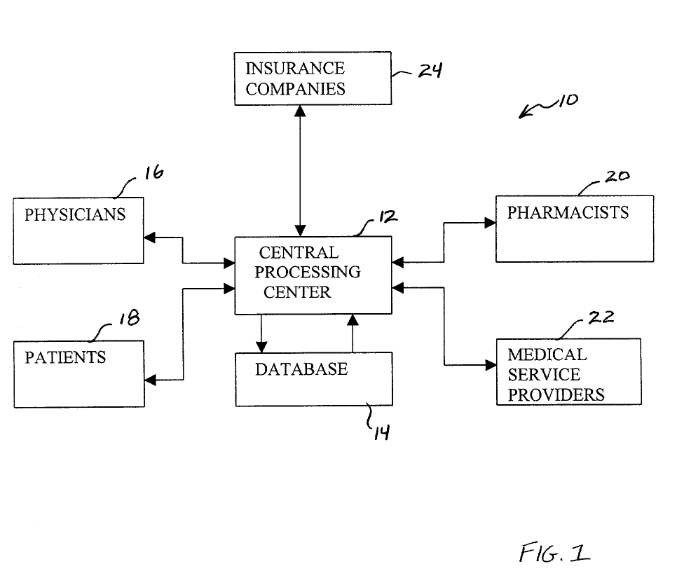

Referring to FIG. 1, a schematic of the overall system 10 is shown. The system 10 includes a central processing center 12. The central processing center 12 maintains a database 14 and runs software that enables authorized users to access data contained within the database 14. As will later be explained, the database 14 contains information regarding both physicians 16 and patients 18. The database 14 also contains information regarding pharmacists 20 or other medical service providers 22 who provide goods or services in accordance with a physician's orders. At the central processing center 12, data is received from both physicians 16 who write prescriptions and the pharmacists 20 or medical service providers 22 who fill the prescriptions. The received data is processed at the central processing center 12 to ensure that the prescriptions are filled properly and that no fraud occurs that is assignable to the physicians 16, patients 18, pharmacists 20 or other medical service providers 22.

Insurance companies 24 that are responsible for paying for the prescriptions may also obtain access to the central processing center 12. If fraud is detected that is relevant to the interests of one of the insurance companies 24, that insurance company can be notified. The insurance company can then take procedural actions or legal actions to correct the fraud and ensure that the fraud does not recur.

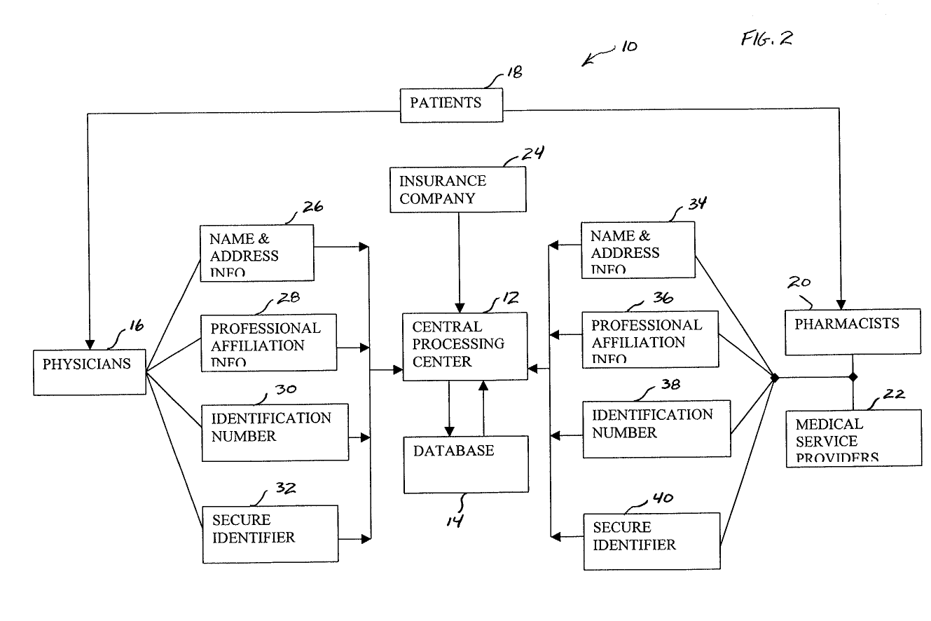

Referring now to FIG. 2, the registration process is outlined. First the central processing center 12 and database 14 are established. The central processing center 12 is loaded with the proper software that performs the method of operation about to be described. Patients 18, physicians 16, pharmacists 20, medical service providers 22 and/or insurance companies 24 can then register to utilize the system 10. If the system 10 is operated by an independent company, then insurance companies 24 can register. However, the present invention system 10 can also be run by a specific insurance company, thus the insurance company would be the systems administrator and registration would not be necessary. Registration can be done either by a direct computer connection, such as through a website, or registration can be completed by filling out physical paper forms.

For physicians 16 to register, each of the physicians provides his/her name, address and related information 26. If physicians 16 are affiliated with a particular practice or hospital, information 28 of that professional affiliation is also provided. Each of the physicians 16 must also provide a unique identification number 30. The identification number 30 can be the physician's medical license number and/or any other identification number that may be warranted. Examples of such identification numbers include, but are not limited to, insurance identification numbers, systems user numbers and the like. Furthermore, each of the physicians 16 that registers must provide at least one secure identifier 32. The secure identifier 32 can be a secret pin number. However, the secure identifier 32 is preferably a biometric identifier such as the physician's signature. Ideally, the secure identifier 32 would be a biometric parameter that is hard to counterfeit, such as a fingerprint or a voice data print.

Pharmacists 20 and medical service providers 22 would also register with the central processing center 12. To register, each of the participating pharmacists 20 or medical service providers 22 provides their name, address and related information 34. If the pharmacists 20 or medical service providers 22 are affiliated with a particular practice or hospital, the professional affiliation information 36 is also provided. Pharmacists 20 and medical service providers 22 must also provide an identification number 38. Examples of such identification numbers 38 include, but are not limited to, license numbers, insurance identification numbers, system user numbers and the like. Furthermore, each of the participating pharmacists 20 and medical service providers 22 must provide at least one secure identifier 40. The secure identifier 40 can be a unique pin number. However, the secure identifier 40 is preferably a biometric identifier such as the pharmacist's signature. Ideally, the secure identifier 40 would be a biometric parameter that is hard to counterfeit, such as a fingerprint or a voice data print.

Patients 18 may directly register with the central processing center 12. However, patients 18 preferably give permission to their physicians 16, pharmacists and/or medical service providers 22 to input the needed medical information into the system 10 on their behalves.

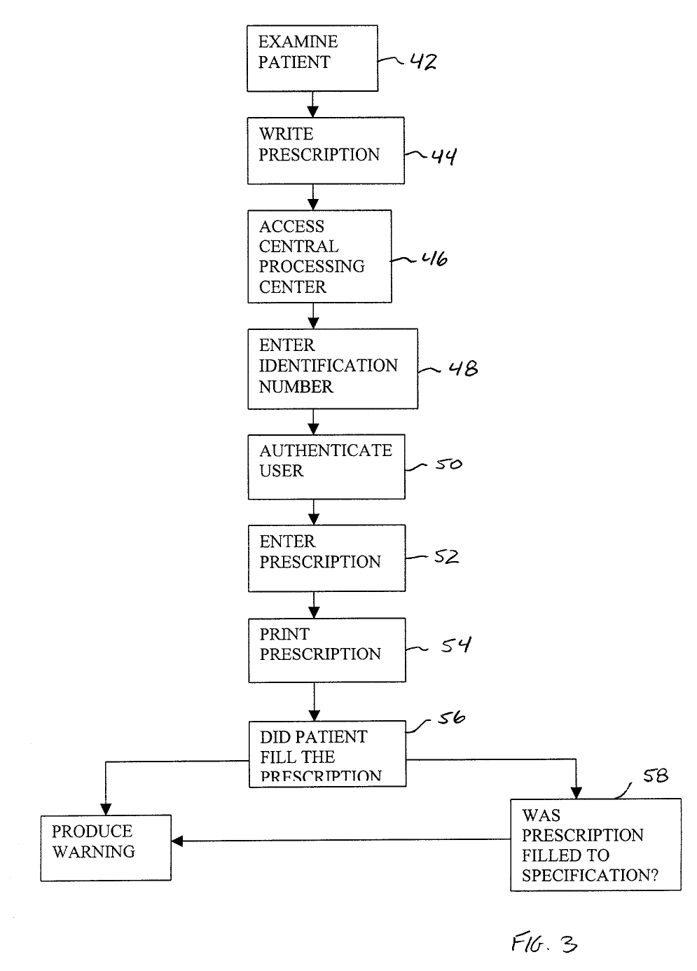

Referring to FIG. 3, the method by which a physic-an uses the present invention system is outlined. As is indicated by Block 42, a physician first examines a patient in the traditional manner. Depending upon the results of that examination, a physician may write a prescription for a pharmaceutical, as is indicated by Block 44. To write the prescription, the physician first accesses the central processing center. A physician can do this using a desktop computer, a laptop computer a palm computer or even a cell phone. See Block 46. Once electronically connected to the central processing center, the physician must enter his/her identity. To do this the physician enters his/her identification number, as is indicated by Block 48. The physician is then prompted to verify their identity using a secret pin number or biometric parameter. See Block 50. To verify a biometric parameter, the device used by the physician to communicate with the central database must have a biometric reader, such as a signature pad, a thumbprint reader or a microphone to receive a voiceprint.

Once a physician has been identified and that identity has been verified, the physician is free to enter the prescription into the central database. See Block 52. The prescription is identified by the patient's name, insurance number, social security number or some other number that is unique to each patient. The physician may type the prescription. Alternatively, a point and click menu can be provided to help the physician select the desired pharmaceutical. After the prescription is stored in the central database, a copy of the prescription can be printed out for both the patient's file and for the patient to take with them when they leave the office. See Block 54.

As is indicated by Block 56, the patient is given a predetermined period of time in which to have the prescription filled. If the prescription is not filled within that period of time, the physician is notified. The notification can be electronic, by mail or by phone. Once notified, the physician can call the patient to inquire about why the prescribed medication is not being taken.

Furthermore, as is indicated by Block 58, and in a manner that will later be explained, the physician is notified through the central database whether or not a pharmacist filled the prescription properly. For example, if the type of pharmaceutical, brand of pharmaceutical, dosage amount or number of pills is altered from the prescription, the physician is notified. The physician can then contact either the pharmacist or patient to inquire about any discrepancies.

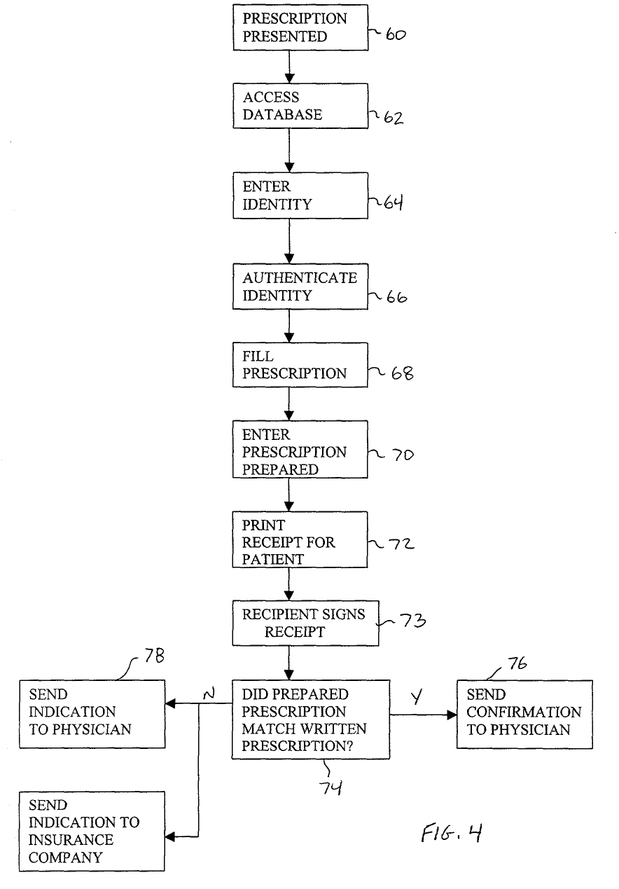

Referring to FIG. 4, the method by which a pharmacist or medical service provider would utilize the present invention system is provided. As is indicated by Block 60, the pharmacist is notified of the existence of a prescription. This can be by a physician calling the pharmacist or by the patient handing the prescription to the pharmacist. The pharmacist accesses the central processing center using a desktop computer, a laptop computer a palm computer or even a cell phone. See Block 62. Once electronically connected to the central processing center, the pharmacist must identify himself/herself. See Block 64. To do this the pharmacist enters his/her license number, user number or any other identification number required. The pharmacist is then prompted to verify his/her identity using a secret pin number or biometric parameter. See Block 66. To verify a biometric parameter, the device used by the pharmacist to communicate with the central processing center must have a biometric reader, such as a signature pad, a thumbprint reader or a microphone to receive a voiceprint.

Once a pharmacist has been identified and that identity has been verified, the pharmacist is free to retrieve the details of the prescription from the database and fill or refill the prescription. See Block 68. Since the pharmacist is receiving the prescription directly through the secure central processing center, no alterations to the prescription can be made by the patient. Furthermore, false prescriptions, or prescriptions cancelled due to patient death, theft or loss, will not be filled because there will be no authorization for that prescription in the database of the central processing center. Accordingly, the ability of a patient or other individual to change, falsify or fake a prescription is effectively eliminated.

After the pharmacist has filled the prescription, the pharmacist must enter information on how that prescription was filled into the database. See Block 70. Among the information entered by the pharmacists are the type of medication administered, the brand of the medication administered, the volume of the medication administered and the number or refills remaining. Through the central processing center, a receipt is then printed for the patient that contains this information. This receipt is presented to the patient along with the filled prescription. See Block 72.

As is indicated by Block 73, the person receiving the prescription must sign the receipt. The receipt is placed on an electronic touch pad. When the receipt is signed on an electronic touch pad, an electronic representation of the signature is stored with the receipt in the electronic database. If a pharmacy ever has to verify who picked up a filled prescription, the electronic signature for any receipt can be electronically retrieved.

As is indicated by Block 74, once the information about the filling of the prescription is entered into the database, the information regarding how the prescription is filled is compared to the original prescription as written by the physician. If the information regarding the filling of the prescription matches the original prescription, a conformation of the prescription's fulfillment is generated, through the database, for the physician's records. See Block 76. However, if the information regarding how the prescription was filled does not match the exact particulars of the original prescription, a warning message is prepared and sent to the original physician through the database. See Block 78. If the error is simple, such as a substitution of equivalent brands, the physician can ignore the warning message. If the error is significant, such as a wrong dosage or medication, the physician can immediately contact the patient and warn of the error and can contact the pharmacist to query about how and why the error was made.

If the filled prescription does not match the prescription written by the physician, one of the following scenarios must have occurred. First, the pharmacist made a mistake in either filling the prescription or entering the prescription into the system. Second, the pharmacist purposely altered the prescription with honorable intentions. Lastly, the pharmacist purposely altered the prescription with dishonorable intentions. As indicated by Block 80, if the data points to an error in filling the prescription that is purposely made by the pharmacist with dishonorable intentions, such as alterations in the number of pills administered or the issuance of generic brands at brand name prices, the central processing center can generate a warning to the insurance company that is paying for the prescription. If the insurance company detects fraud by a pharmacist or a pattern of fraud by a particular pharmacy, the insurance company can take appropriate actions, be they administrative or legal.

The database used by the present invention system will contain a record of all the prescriptions prescribed by a physician to a particular patient and all the prescriptions actually filled by a particular patient. This database can therefore be linked to other systems that utilize this information. For example, many pharmacy chains use software that warns of dangerous drug interactions. The database of the present invention system can be used to provide data to such secondary programs. Furthermore, pharmacies can use the data contained in the present invention system to monitor how many pharmaceuticals are distributed in a predetermined period of time. Accordingly, data from the database can be used for inventory purposes.

Physicians can use the data contained in the database of the present invention system to track the medication history of a particular patient. This is especially useful for patients that travel or use public health services and often do not see the same doctor more than once.

The present invention system also enables patients to renew their prescriptions different pharmacies, provided the pharmacies are part of the system. The present invention system electronically stores the information concerning the prescription including the number of times it has been renewed. As such, any pharmacy that is part of the system can access this information and renew a prescription. This is highly advantageous for a patient that moves, or is otherwise traveling.

It will be understood that the system and method of the present invention described and illustrated are merely exemplary and a person skilled in the art can make many variations to the shown embodiment. All such alternate embodiments and modifications are intended to be included within the scope of the present invention as defined below in the claims.

What is claimed is:

1. A method of tracking the execution of a medical prescription by medical service professionals, said method comprising the steps of:
providing a database;
entering an unfilled prescription into said database, that has been prescribed by a physician to a particular patient;
retrieving said unfilled prescription from said database by a medical service professional selected by said particular patient to fill said prescription;
having the medical service provider fill said unfilled prescription and present a filled prescription to said particular patient;
entering data of said filled prescription into said database;
comparing said data of said filled prescription with said unfilled prescription; and
generating a warning if said data of said filled prescription does not satisfy said unfilled prescription.

2. The method according to claim 1, wherein said step of entering a prescription includes the substeps of:
having a physician access said database;
authenticating the identity of said physician; and
having said physician enter said prescription into said database.

3. The method according to claim 1, wherein said step of retrieving said unfilled prescription from said database includes the substeps of:
having said medical service professional access said database;
authenticating the identity of said medical service provider; and
providing said medical service professional with said unfilled prescription through said database.

4. The method according to claim 1, further including the step of registering physicians authorized to access said database.

5. The method according to claim 1, further including the step of registering medical service professionals authorized to access said database.

6. The method according to claim 1, wherein said step of entering data on said filled prescription includes entering medication type, medication brand, medication amount and medication cost.

7. The method according to claim 1, wherein said step of generating a warning includes providing a warning to said physician that said unfilled prescription was not filled to specification.

8. The method according to claim 1, wherein said step of generating a warning includes providing a warning to an insurance company that said medical service provider failed to properly fill said unfilled prescription.

9. The method according to claim 1, wherein said database is maintained at a central facility and said database is accessed by said physician and said medical service provider by a telecommunications link.

10. The method according to claim 2, wherein said sub-step of authenticating the identity of said physician includes verifying a biometric characteristic of said physician.

11. The method according to claim 3, wherein said sub-step of authenticating the identity of said medical service provider includes verifying a biometric characteristic of said medical service provider.

12. A method of reducing fraud and mistake in the filling of medical prescriptions for at least one pharmaceutical, said method comprising the steps of:
entering a patient's unfilled prescription for at least one pharmaceutical into a secure database;
retrieving said unfilled prescription from said database at a pharmacy;
having a pharmacist at said pharmacy provide a volume of said at least one pharmaceutical as directed by said unfilled prescription;
entering said at least one pharmaceutical and said volume provided by said pharmacist into said database;
comparing said at least one pharmaceutical and said volume provided by said pharmacist to said unfilled prescription; and
generating a warning if either said at least one pharmaceutical or said volume differ from said unfilled prescription.

13. The method according to claim 12, wherein said step of entering a patient's unfilled prescription includes the substeps of:
having a physician access said database;
authenticating the identity of said physician; and
having said physician enter said unfilled prescription into said database.

14. The method according to claim 12, wherein said step of retrieving said unfilled prescription from said database includes the substeps of:
having said pharmacist access said database;
authenticating the identity of said pharmacist; and
providing said pharmacist with said unfilled prescription through said database.

15. The method according to claim 12, further including the step of registering physicians authorized to access said database.

16. The method according to claim 12, further including the step of registering pharmacists authorized to access said database.

17. The method according to claim 12, wherein said step of generating a warning includes providing a warning to said physician that said unfilled prescription was not filled to specification.

18. The method according to claim 12, wherein said step of generating a warning includes providing a warning to an insurance company that said pharmacist failed to properly fill said unfilled prescription.

19. The method according to claim 13, wherein said sub-step of authenticating the identity of said physician includes verifying a biometric characteristic of said physician.

20. The method according to claim 14, wherein said sub-step of authenticating the identity of said pharmacist includes verifying a biometric characteristic of said pharmacist.
